(19) United States
(12) Patent Application Publication
(10) Pub. No.: US 2026/0192603 A1
(43) Pub. Date: Jul. 9, 2026

(54) TIRE

(71) Applicant: The Yokohama Rubber Co., LTD., Kanagawa (JP)

(72) Inventor: Kakeru YATABE, Kanagawa (JP)

(21) Appl. No.: 19/130,763

(22) PCT Filed: Nov. 21, 2023
(86) PCT No.: PCT/JP2023/041839

§ 371 Date: May 16, 2025

(30) Foreign Application Priority Data
Nov. 21, 2022 (JP) 2022-185846

(51) Int. Cl. B60C 11/03; B60C 11/12

(52) U.S. Cl. CPC B60C 11/0318; B60C 11/1204; B60C 11/1236; B60C 2011/0346; B60C 2011/0353; B60C 2011/1213; B60C 2011/1254

(57) ABSTRACT

In a tire, a first shoulder main groove has a zigzag shape made by alternately connecting long portions and short portions. Further, a second center main groove has a bent shape formed by connecting a first groove portion having a circumferential length L31, a second groove portion having a circumferential length L32, and a third groove portion having a circumferential length L33. The circumferential lengths L31 to L33 of the first to third groove portions have the relationship L31>L32≥L33.

### TECHNICAL FIELD

The technology relates to a tire and particularly relates to a tire with improved snow performance of a tire.

### BACKGROUND ART

In recent years, all-season tires used in snowy areas have adopted main grooves having a zigzag shape to improve the snow performance of the tire. As a known tire adopting such a structure, a technology described in Japan Unexamined Patent Publication No. 2016-113066 A is known.

### SUMMARY

The technology provides a tire with improved snow performance of a tire.

A tire according to the technology is a tire including a plurality of main grooves extending in a tire circumferential direction; and a plurality of land portions defined and formed by the plurality of main grooves; the plurality of main grooves including a first center main groove and a second center main groove adjacent to each other with a tire equatorial plane interposed between the first center main groove and the second center main groove, the plurality of land portions including a center land portion defined and formed by the first center main groove and the second center main groove, the first center main groove having a zigzag shape formed by alternately connecting a long portion and a short portion, the second center main groove having a bent shape formed by connecting a first groove portion having a circumferential length L31, a second groove portion having a circumferential length L32, and a third groove portion having a circumferential length L33, and the circumferential lengths L31 to L33 of the first groove portion to the third groove portion having a relationship L31>L32≥L33.

In the tire according to the technology, (1) a first center main groove 22 has the zigzag shape formed by alternately connecting long portions and short portions, and a second center main groove has the bent shape formed by the first to third groove portions. Therefore, edge components of a tread portion center region are ensured, and the snow performance of the tire is improved. Further, (2) when the first center main groove is located in an outer region in the vehicle width direction and the second center main groove is located in an inner region in the vehicle width direction in a state where the tire is mounted on a vehicle, the uneven wear resistance performance of the tire is ensured by the first center main groove having a zigzag shape with fewer bend points, and the snow performance of the tire is effectively enhanced by the second center main groove having a bent shape with more bend points. This has the advantage of providing the snow performance of the tire and the uneven wear resistance performance of the tire in a compatible manner.

### BRIEF DESCRIPTION OF DRAWINGS

FIG. 1 is a cross-sectional view in a tire meridian direction illustrating a tire according to an embodiment of the technology.

FIG. 2 is a plan view illustrating a tread surface of the tire illustrated in FIG. 1.

FIG. 3 is an enlarged view illustrating an outer region in a vehicle width direction of the tire illustrated in FIG. 2.

FIG. 4 is an enlarged view illustrating an outer middle land portion illustrated in FIG. 3.

FIG. 5 is a perspective view illustrating a chamfered portion of the outer middle land portion illustrated in FIG. 4.

FIG. 6 is an enlarged view illustrating a tread portion center region of the tire illustrated in FIG. 2.

FIG. 7 is an enlarged view illustrating a center land portion illustrated in FIG. 6.

FIG. 8 is a cross-sectional view in a groove length direction illustrating a second center lug groove of the center land portion illustrated in FIG. 7.

FIG. 9 is a perspective view illustrating a chamfered portion of the center land portion illustrated in FIG. 7.

FIG. 10 is an enlarged view illustrating an inner region in the vehicle width direction of the tire illustrated in FIG. 2.

FIG. 11 is an enlarged view illustrating an inner middle land portion illustrated in FIG. 10.

FIG. 12 is a cross-sectional view illustrating a notch portion of inner middle lug grooves illustrated in FIG. 11.

FIG. 13 is a table showing results of performance tests of tires according to embodiments of the technology.

FIG. 14 is a table showing results of performance tests of tires according to embodiments of the technology.

### DETAILED DESCRIPTION

Embodiments of the technology will be described in detail below with reference to the drawings. Note that the technology is not limited to the embodiments. Constituents of the embodiments include constituents that are substitutable and are obviously substitutes while maintaining consistency with the embodiments of the technology. A plurality of modified examples described in the embodiments can be combined in a discretionary manner within the scope obvious to one skilled in the art.

### Tire

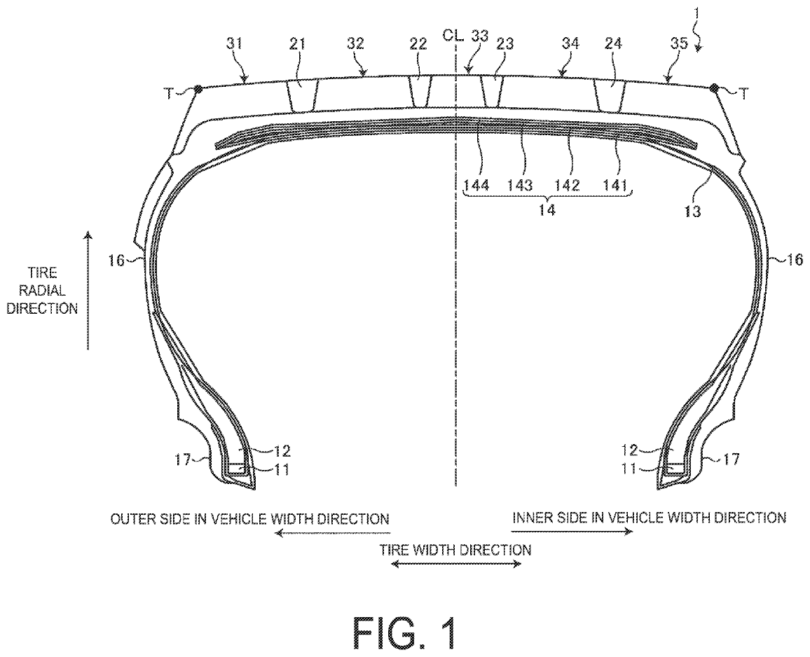

FIG. 1 is a cross-sectional view in a tire meridian direction illustrating a tire 1 according to an embodiment of the technology. The same drawing illustrates a cross-sectional view of a half region in a tire radial direction. The same drawing also illustrates a pneumatic radial tire for a sports utility vehicle (SUV) as an example of a tire.

In the same drawing, a cross-section in the tire meridian direction is defined as a cross-section of the tire taken along a plane that includes a tire rotation axis (not illustrated). Further, a tire equatorial plane CL is defined as a plane perpendicular to the tire rotation axis through a midpoint between measurement points in a tire cross-sectional width defined by the Japan Automobile Tyre Manufacturers Association, Inc. (JATMA). A tire width direction is defined as a direction parallel to the tire rotation axis, and the tire radial direction is defined as a direction perpendicular to the tire rotation axis.

Furthermore, an inner side in a vehicle width direction and an outer side in the vehicle width direction are defined with respect to the vehicle width direction in a case where the tire is mounted on a vehicle. Additionally, left and right regions demarcated by the tire equatorial plane are defined as an outer region in the vehicle width direction and an inner region in the vehicle width direction. Furthermore, the tire includes a mounting direction indicator (not illustrated) that indicates the tire mounting direction with respect to a vehicle. Examples of the mounting direction indicator portion include a mark and a recess/protrusion on a sidewall portion of the tire. For example, Regulation No. 30 of the Economic Commission for Europe Regulation (ECE R30) mandates that a vehicle mounting direction indicator be provided on the sidewall portion on the outer side in the vehicle width direction in a case where the tire is mounted on a vehicle.

The tire 1 has an annular structure centered on the tire rotation axis, and includes a pair of bead cores 11, 11, a pair of bead fillers 12, 12, a carcass layer 13, a belt layer 14, a tread rubber, a pair of sidewall rubbers 16, 16, and a pair of rim cushion rubbers 17, 17 (see FIG. 1).

The pair of bead cores 11, 11 respectively include one or a plurality of bead wires made of steel and wound in an annular shape a plurality of times, are embedded in bead portions, and constitute cores of the left and right bead portions. The pair of bead fillers 12, 12 are respectively disposed on an outer circumference of the pair of bead cores 11, 11 in the tire radial direction and reinforce the bead portions.

The carcass layer 13 has a single layer structure including one carcass ply or a multilayer structure including a plurality of carcass plies layered, extends in a toroidal shape between the left and right bead cores 11, 11, and constitutes the backbone of the tire. Both end portions of the carcass layer 13 are turned back toward outer sides in the tire width direction and fixed to wrap the bead cores 11 and the bead fillers 12. The carcass ply of the carcass layer 13 is made by covering a plurality of carcass cords made of steel or an organic fiber material (for example, aramid, nylon, polyester, or rayon) with a coating rubber and performing a rolling process on the carcass cords, and has a cord angle (defined as an inclination angle of the carcass cords in a longitudinal direction with respect to a tire circumferential direction) of 80 degrees or more and 100 degrees or less.

The belt layer 14 is formed by layering a plurality of belt plies 141 to 144 and is disposed around an outer circumference of the carcass layer 13. The belt plies 141 to 144 include a pair of cross belts 141, 142 and a plurality of belt covers 143, 144.

The pair of cross belts 141, 142 are made by covering a plurality of belt cords made of steel or an organic fiber material with a coating rubber and performing a rolling process on the belt cords and have a cord angle of 15 degrees or more and 55 degrees or less as an absolute value. Further, the pair of cross belts 141, 142 have cord angles (defined as inclination angles in longitudinal directions of the belt cords with respect to the tire circumferential direction) of mutually opposite signs and are layered such that the longitudinal directions of the belt cords intersect each other (so-called crossply structure). The pair of cross belts 141, 142 are disposed in a layered manner on an outer side of the carcass layer 13 in the tire radial direction.

The belt covers 143, 144 are made by coating belt cover cords made from steel or an organic fiber material with a coating rubber and have a cord angle, as an absolute value, of 0 degrees or more and 10 degrees or less. Additionally, the belt covers 143, 144 are made of, for example, strip materials formed by coating one or a plurality of belt cover cords with a coating rubber, and are formed by winding the strip materials spirally on the outer circumferential surfaces of the cross belts 141, 142 multiple times in the tire circumferential direction. Additionally, the plurality of belt covers 143, 144 are disposed covering all the cross belts 141, 142.

The tread rubber is disposed on an outer circumference of the carcass layer 13 and the belt layer 14 in the tire radial direction and constitutes a tread portion of the tire. The pair of sidewall rubbers 16, 16 are respectively disposed on an outer side of the carcass layer 13 in the tire width direction to constitute left and right sidewall portions. The pair of rim cushion rubbers 17, 17 extend from an inner side in the tire radial direction of the left and right bead cores 11, 11 and turned back portions of the carcass layer 13 toward the outer side in the tire width direction and constitute rim fitting surfaces of the bead portions.

### Tread Pattern

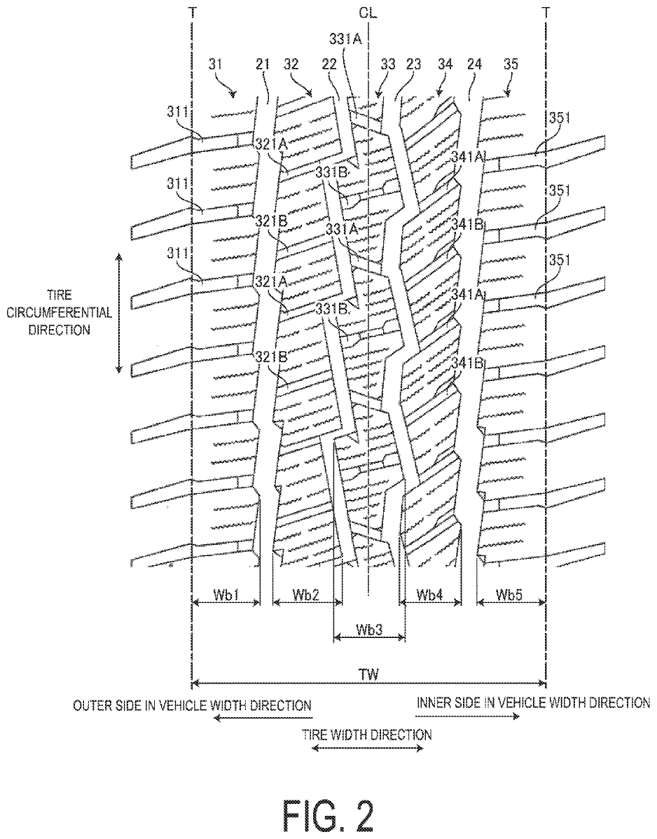

FIG. 2 is a plan view illustrating a tread surface of the tire 1 illustrated in FIG. 1. The same drawing illustrates a tread surface of an all-season tire. In the same drawing, “tire circumferential direction” refers to a direction about the tire rotation axis. A reference sign T denotes a tire ground contact edge, and a dimension symbol TW denotes a tire ground contact width.

As illustrated in FIG. 2, the tire 1 includes, in the tread surface, four main grooves 21 to 24 and five land portions 31 to 35 defined and formed by these main grooves 21 to 24.

The main grooves 21 to 24 include outer and inner shoulder main grooves 21, 24 and outer and inner center main grooves 22, 23. The main grooves 21 to 24 have an annular structure extending continuously along the entire circumference of the tire in the tire circumferential direction. The shoulder main grooves 21, 24 are main grooves located on the outermost side in the tire width direction and are defined in respective left and right regions demarcated by the tire equatorial plane CL. In addition, the outer shoulder main groove 21 and the outer center main groove 22 are located in an outer region in the vehicle width direction demarcated by the tire equatorial plane CL, and the inner center main groove 23 and the inner shoulder main groove 24 are located in an inner region in the vehicle width direction demarcated by the tire equatorial plane CL.

The main grooves 21 to 24 are grooves on which a wear indicator must be provided as specified by JATMA. Further, long portions of the zigzag shape of the main grooves 21, 22, 24 and a first groove portion of the bent shape of the main groove 23 described below have a groove width of 2.5 mm or more and 15.0 mm or less and a groove depth of 8.0 mm or more and 12.0 mm or less.

The groove width is measured as a distance between groove walls opposed to each other in a groove opening portion when the tire is mounted on a specified rim, inflated to a specified internal pressure, and in an unloaded state. In a configuration in which the groove opening portion includes a notch portion or a chamfered portion, the groove width is measured with intersection points between an extension line of the tread contact surface and extension lines of the groove walls as measurement points, in a cross-sectional view parallel with the groove width direction and the groove depth direction.

The groove depth is measured as a distance from the tread contact surface to a groove bottom when the tire is mounted on a specified rim, inflated to a specified internal pressure, and in an unloaded state. In a configuration in which the groove bottom includes partial recess/protrusion portions or a sipe, the groove depth is measured excluding the partial recess/protrusion portions or the sipe.

“Specified rim” refers to a “standard rim” defined by JATMA, a “Design Rim” defined by the Tire and Rim Association, Inc. (TRA), or a “Measuring Rim” defined by the European Tyre and Rim Technical Organisation (ETRTO). “Specified internal pressure” refers to a “maximum air pressure” specified by JATMA, the maximum value in “TIRE LOAD LIMITS AT VARIOUS COLD INFLATION PRESSURES” specified by TRA, or “INFLATION PRESSURES” specified by ETRTO. A specified load refers to a “maximum load capacity” specified by JATMA, the maximum value in “TIRE LOAD LIMITS AT VARIOUS COLD INFLATION PRESSURES” specified by TRA, or “LOAD CAPACITY” specified by ETRTO. However, in JATMA, in the case of a tire for a passenger vehicle, the specified internal pressure is an air pressure of 180 kPa, and the specified load is 88% of the maximum load capacity at the specified internal pressure.

The land portions 31 to 35 include inner and outer shoulder land portions 31, 35, inner and outer middle land portions 32, 34, and one row of center land portion 33. The land portions 31 to 35 are defined and formed by the main grooves 21 to 24 and form an annular road contact surface that extends along the entire circumference of the tire. The shoulder land portions 31, 35 are defined as land portions that are defined by the shoulder main grooves 21, 24 and located on the outer side in the tire width direction. The middle land portions 32, 34 are defined as land portions that are defined by the shoulder main grooves 21, 24 and located on the inner side in the tire width direction. Further, the outer shoulder land portion 31 and the outer middle land portion 32 are located in the outer region in the vehicle width direction demarcated by the tire equatorial plane CL. Additionally, the center land portion 33 is located on the tire equatorial plane CL. The inner middle land portion 34 and the inner shoulder land portion 35 are located in the inner region in the vehicle width direction.

In FIG. 2, maximum ground contact widths Wb1, Wb5 of the outer and inner shoulder land portions 31, 35 with respect to the tire ground contact width TW are in the range of 20% or more and 60% or less, and preferably in the range of 35% or more and 45% or less. Further, maximum ground contact widths Wb2, Wb4 of the outer and inner middle land portions 32, 34 with respect to the tire ground contact width TW are in the range of 20% or more and 50% or less. Furthermore, a maximum ground contact width Wb3 of the center land portion 33 with respect to the tire ground contact width TW is in the range of 30% or more and 40% or less.

The ground contact widths of the land portions are each measured as a linear distance in the tire axial direction in a contact surface of the land portion and a flat plate, when the tire is mounted on a specified rim, inflated to a specified internal pressure, placed perpendicular to the flat plate in a static state, and subjected to a load corresponding to a specified load.

The tire ground contact width TW is measured as a linear distance in the tire axial direction of a contact surface of the tire and a flat plate when the tire is mounted on a specified rim, inflated to a specified internal pressure, placed perpendicular to the flat plate in a static state, and subjected to a load corresponding to a specified load.

The tire ground contact edge T is defined as a maximum width position in the tire axial direction of the contact surface between the tire and a flat plate when the tire is mounted on a specified rim, inflated to a specified internal pressure, placed perpendicular to the flat plate in a static state, and loaded with a load corresponding to a specified load.

### Outer Shoulder Main Groove and Outer Center Main Groove

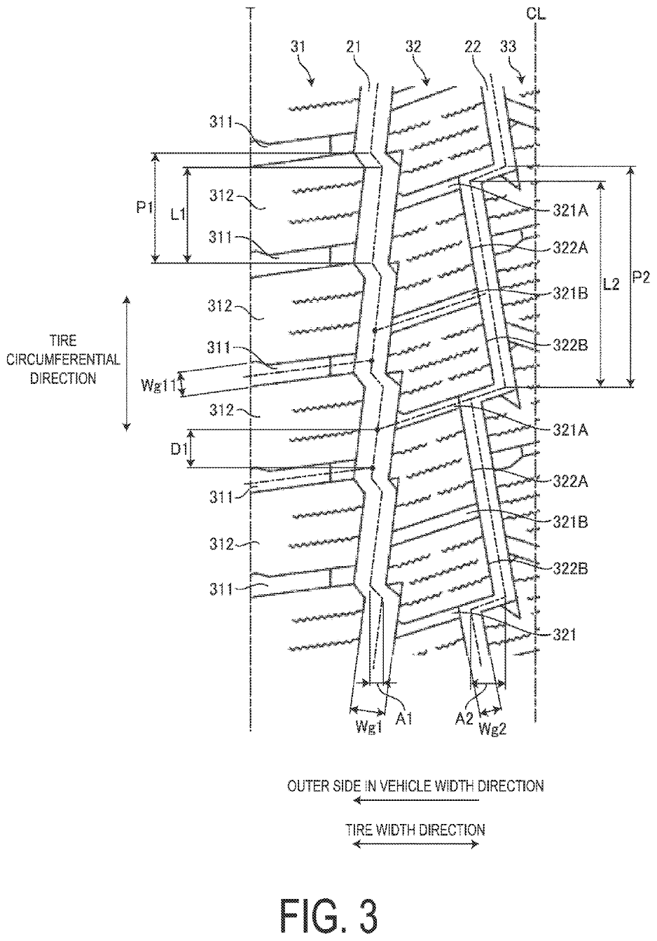

FIG. 3 is an enlarged view illustrating the outer region in the vehicle width direction of the tire 1 illustrated in FIG. 2. The same drawing illustrates a ground contact region on the outer side in the vehicle width direction demarcated by the tire equatorial plane CL.

As illustrated in FIG. 3, the outer shoulder main groove 21 has a zigzag shape made by alternately connecting long portions and short portions. Additionally, a circumferential length L1 of the long portion of the outer shoulder main groove 21 is in the range 0.70≤L1/P1≤0.95 with respect to a pitch length P1 of the zigzag shape of the outer shoulder main groove 21, and is preferably in the range 0.80≤L1/P1≤0.90. The lower limit described above ensures the effect of improving snow discharge properties on snowy road surfaces due to the zigzag shape having the long portion, and the upper limit described above ensures the length of the short portion, thereby ensuring snow traction properties of the tire. Further, a pitch number N1 of the zigzag shape of the outer shoulder main groove 21 is in the range 60≤N1≤100.

The zigzag shape of the main groove is defined as a shape of a groove center line of the main groove in a tread plan view.

The groove center line is defined as an imaginary line connecting midpoints of edge points of the groove width. In addition, the groove center line of the main groove is defined by excluding partial recess/protrusion portions (for example, an opening portion of a lug groove or a sipe, or a chamfered portion or a notch portion of the land portion) formed at an opening portion of the main groove in the tread contact surface.

The circumferential length of the groove portion is measured as the length in the tire circumferential direction beginning at a bend point of the groove center line of the main groove.

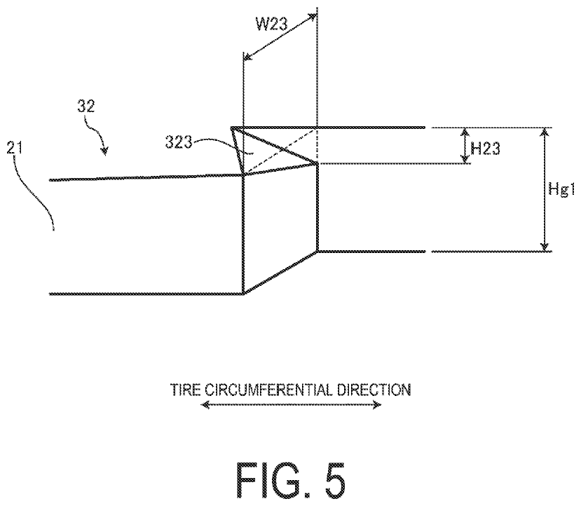

Additionally, in FIG. 3, an amplitude A1 of the zigzag shape of the outer shoulder main groove 21 is in the range 0.15≤A1/Wg1≤0.50 with respect to a groove width Wg1 of the outer shoulder main groove 21, and preferably in the range 0.25≤A1/Wg1≤0.35. The lower limit described above ensures the effect of improving snow traction performance by the zigzag shape, and the upper limit described above suppresses generation of uneven wear due to excessive enlargement of the amplitude. The groove width Wg1 of the outer shoulder main groove 21 is in the range 8.5 mm≤Wg1≤16.0 mm, and a groove depth Hg1 (see FIG. 5 described below) is in the range 8.0 mm≤Hg1≤12.0 mm.

In the configuration of FIG. 3, the outer shoulder main groove 21 has a see-through structure in the tire circumferential direction. In other words, the groove width Wg1 and the amplitude A1 of the outer shoulder main groove 21 are ensured such that edge portions of the left and right land portions 31, 32 defined by the outer shoulder main groove 21 do not overlap each other as viewed in the tire circumferential direction. This can improve snow discharge properties on snowy road surfaces while ensuring the effect of improving snow traction performance.

As illustrated in FIG. 3, the outer center main groove 22 has a zigzag shape made by alternately connecting long portions and short portions. Further, the long portion of the outer center main groove 22 is inclined in an opposite direction in the tire circumferential direction with respect to the long portion of the outer shoulder main groove 21. Specifically, in the configuration of FIG. 3, the long portion of the outer shoulder main groove 21 is inclined toward the tire ground contact edge T side toward the lower side in the drawing, and the long portion of the outer center main groove 22 is inclined toward the tire equatorial plane CL side toward the lower side in the drawing.

In the above configuration, (1) the outer shoulder main groove 21 and the outer center main groove 22 have a zigzag shape made by alternately connecting long portions and short portions. Therefore, compared to a configuration (not illustrated) in which the main groove has a zigzag shape made by connecting groove portions having the same length, snow discharge properties on snowy road surfaces are improved, and the snow performance of the tire is improved. Further, (2) the long portions of the zigzag shapes of the adjacent main grooves 21, 22 are inclined in mutually opposite directions with respect to the tire circumferential direction. Therefore, compared to a configuration (not illustrated) in which long portions are inclined in an identical direction with respect to the tire circumferential direction, the effect of improving snow traction performance due to the zigzag shapes is ensured.

Additionally, in FIG. 3, a circumferential length L2 of the long portion of the outer center main groove 22 is in the range 0.60≤L2/P2≤1.00 with respect to a pitch length P2 of the zigzag shape of the outer center main groove 22, and is preferably in the range 0.80≤L2/P2≤0.95. The lower limit described above ensures an effect of improving snow discharge properties on snowy road surfaces due to the zigzag shape having the long portion, and the upper limit described above ensures the length of the short portion, thereby ensuring snow traction properties of the tire. When L2/P2=1.00, the groove center line of the short portion of the outer center main groove 22 is parallel to the tire axial direction.

In addition, in FIG. 3, the pitch length P2 of the zigzag shape of the outer center main groove 22 is in the range 1.50≤P2/P1≤3.00 with respect to the pitch length P1 of the zigzag shape of the outer shoulder main groove 21, preferably in the range 2.00≤P2/P1≤2.50. Therefore, the pitch length P2 of the outer center main groove 22 is large, and the pitch length P1 of the outer shoulder main groove 21 is small. As a result, the rigidity of the tread portion center region is ensured, thereby suppressing uneven wear of the tire, and edge components of the tread portion shoulder region are ensured, thereby ensuring the snow traction performance of the tire. A pitch number N2 of the zigzag shape of the outer center main groove 22 is in the range 30≤N2≤50. Further, in the configuration of FIG. 3, the pitch number N2 of the outer center main groove 22 is set such that N2/N1=1/2 with respect to the pitch number N1 of the outer shoulder main groove 21.

Additionally, in FIG. 3, an amplitude A2 of the zigzag shape of the outer center main groove 22 is in the range 1.40≤A2/Wg2≤1.90 with respect to a groove width Wg2 of the outer center main groove 22, and is preferably in the range 1.60≤A2/Wg2≤1.70. The lower limit described above ensures the effect of improving snow traction performance by the zigzag shape, and the upper limit described above suppresses generation of uneven wear due to excessive enlargement of the amplitude.

In addition, in FIG. 3, the amplitude A2 of the zigzag shape of the outer center main groove 22 is in the range 2.00≤A2/A1≤4.00 with respect to the amplitude A1 of the zigzag shape of the outer shoulder main groove 21, preferably in the range 2.50≤A2/A1≤3.50. Therefore, the amplitude A2 of the outer center main groove 22 is larger than the amplitude A1 of the outer shoulder main groove 21. As a result, compared to a configuration (not illustrated) in which both have substantially the same amplitude, edge components of the tread portion center region are ensured, thereby ensuring the snow traction performance of the tire, and the rigidity of the tread portion shoulder region is ensured, thereby suppressing uneven wear of the tire.

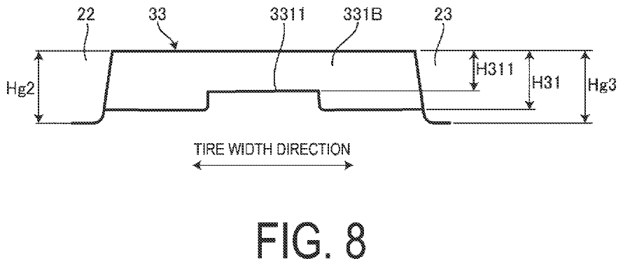

In addition, in FIG. 3, the groove width Wg2 of the outer center main groove 22 is in the range 5.0 mm≤Wg2≤10.0 mm, and a groove depth Hg2 (see FIG. 8 described below) is in the range 8.0 mm≤Hg2≤12.0 mm. The lower limit described above ensures the groove volume of the outer center main groove 22, thus ensuring the snow performance of the tire, and the upper limit described above ensures the rigidity of the tread portion center region, thus ensuring the uneven wear resistance performance of the tire.

Further, in the configuration of FIG. 3, the groove width (dimension symbol omitted in the drawings) of the short portion of the zigzag shape of the outer center main groove 22 is narrower than the groove width of the long portion. In addition, the groove width of the short portion is in the range of 30% or more and 70% or less with respect to the groove width of the long portion, and preferably in the range of 45% or more and 55% or less. The configuration described above is preferable in that the rigidity of the land portions 32 and 33 is ensured and the uneven wear resistance performance of the tire is ensured particularly in a configuration in which an inclination angle of the short portion with respect to the tire circumferential direction is large as illustrated in FIG. 3. However, no such limitation is intended, and the short portion and the long portion of the outer center main groove 22 may have a uniform groove width (not illustrated).

Additionally, in FIG. 3, the groove width Wg2 of the outer center main groove 22 is in the range 0.50≤Wg2/Wg1≤0.80 with respect to the groove width Wg1 of the outer shoulder main groove 21, and is preferably in the range 0.60≤Wg2/Wg1≤0.70. Therefore, the groove width Wg2 of the outer center main groove 22 is narrower than the groove width Wg1 of the outer shoulder main groove 21. Accordingly, the snow performance of the tire is improved compared with a configuration (not illustrated) where both have approximately the same groove width.

Further, in the configuration of FIG. 3, the outer center main groove 22 has a see-through-less structure in the tire circumferential direction. In other words, the groove width Wg2 and the amplitude A2 of the outer center main groove 22 is set such that edge portions of the left and right land portions 32, 33 defined by the outer center main groove 22 overlap each other as viewed in the tire circumferential direction.

### Outer Shoulder Land Portion

As illustrated in FIG. 3, the outer shoulder land portion 31 includes an outer shoulder lug groove 311 and an outer shoulder block 312.

The outer shoulder lug groove 311 has a straight shape or a gentle arc shape, extends through the outer shoulder land portion 31 in the tire width direction, and is connected to the tire ground contact edge T and the outer shoulder main groove 21. Additionally, the outer shoulder lug groove 311 is connected to an end portion of the long portion of the zigzag shape of the outer shoulder main groove 21, and is connected to a maximum amplitude position toward the tire ground contact edge T side of the zigzag shape of the outer shoulder main groove 21. Further, the outer shoulder main groove 21 has a raised bottom portion (reference sign omitted in drawings) at an opening portion on the outer shoulder main groove 21 side. Additionally, a plurality of the outer shoulder lug grooves 311 are arrayed at a predetermined interval in the tire circumferential direction. Additionally, a groove width Wg11 of the outer shoulder lug groove 311 is in the range of 5.0 mm or more and 10.0 mm or less, and a groove depth Hg11 (dimension symbol omitted in the drawings) of the outer shoulder lug groove 311 is in the range of 6.0 mm or more and 11.0 mm or less.

The outer shoulder block 312 is defined and formed by the plurality of outer shoulder lug grooves 311. Additionally, an edge portion of the outer shoulder block 312 on the outer shoulder main groove 21 side is defined by a pair of the long portion and the short portion of the outer shoulder main groove 21 and has a V shape projecting toward the tire equatorial plane CL side. This ensures the rigidity of the block and suppresses uneven wear of the tire.

Additionally, as illustrated in FIG. 3, the outer shoulder block 312 includes a plurality of sipes (reference sign omitted in drawings). As a result, the snow performance of the tire is improved.

### Outer Middle Land Portion

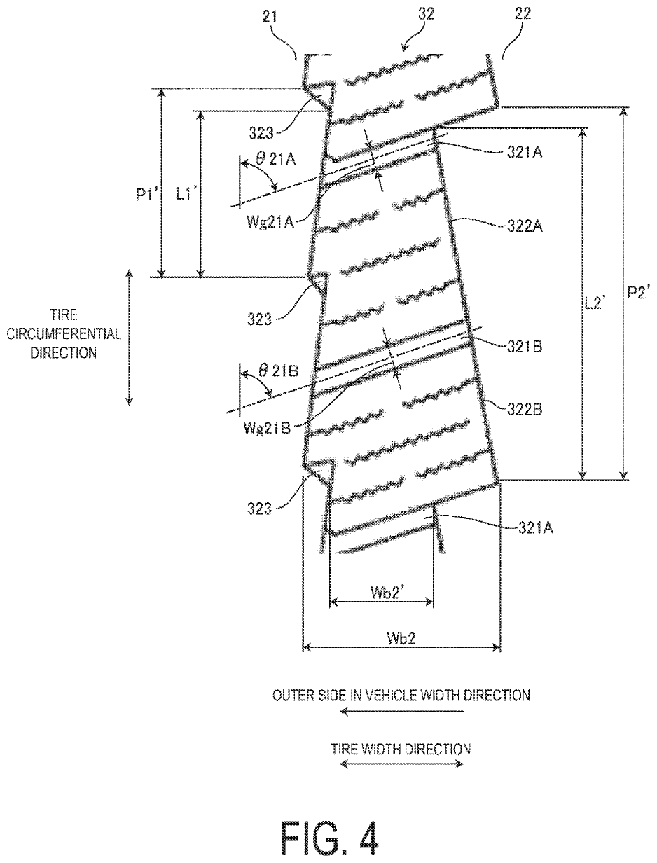

FIG. 4 is an enlarged view illustrating the outer middle land portion 32 illustrated in FIG. 3.

As illustrated in FIG. 3, the outer middle land portion 32 includes a first outer middle lug groove 321A and a second outer middle lug groove 321B, and a first outer middle block 322A and a second outer middle block 322B.

The first and second outer middle lug grooves 321A, 321B have a straight shape or a gentle arc shape, extend through the outer middle land portion 32 in the tire width direction, and are connected to the outer shoulder main groove 21 and the outer center main groove 22. The first and second outer middle lug grooves 321A, 321B are inclined in an identical direction with respect to the tire circumferential direction.

Further, one end portion of each of the first and second outer middle lug grooves 321A, 321B is connected to a central portion of the long portion of the zigzag shape of the outer shoulder main groove 21 while being spaced apart from a maximum amplitude position of the zigzag shape of the outer shoulder main groove 21. Additionally, the other end portion of the first outer middle lug groove 321A is connected to an end portion of the long portion of the zigzag shape of the outer center main groove 22, and is connected to a maximum amplitude position toward the tire ground contact edge T side of the zigzag shape of the outer center main groove 22. On the other hand, the other end portion of the second outer middle lug groove 321B is connected to a central portion of the long portion of the zigzag shape of the outer center main groove 22 while being spaced apart from the maximum amplitude position of the zigzag shape of the outer center main groove 22.

In addition, in FIG. 3, a groove width Wg21 (Wg21A, Wg21B; see FIG. 4) of the first and second outer middle lug grooves 321A, 321B is in the range 0.40≤Wg21/Wg2≤0.80 with respect to the groove width Wg2 of the long portion of the outer center main groove 22, and preferably in the range 0.50≤Wg21/Wg2≤0.70. Additionally, the groove width Wg21 of the outer middle lug grooves 321A, 321B is in the range 2.0 mm≤Wg21≤5.0 mm.

Further, as illustrated in FIG. 3, the first and second outer middle lug grooves 321A, 321B are inclined in an identical direction in the tire circumferential direction with respect to the long portion of the zigzag shape of the outer shoulder main groove 21. Further, in FIG. 4, an inclination angle θ21 (θ21A, θ21B) of the first and second outer middle lug grooves 321A, 321B is in the range 60°≤θ21≤90°.

Additionally, in the configuration of FIG. 3, the first outer middle lug groove 321A extends so as to extend the short portion of the zigzag shape of the outer center main groove 22 in the tire width direction. Specifically, as illustrated in FIG. 4, one groove wall (upper side in the drawing) of the first outer middle lug groove 321A on the outer center main groove 22 side is connected flush with a groove wall of the short portion of the outer center main groove 22. Accordingly, the snow discharge properties of the outer center main groove 22 and the first outer middle lug groove 321A are improved.

Further, as illustrated in FIG. 3, a connection portion of the outer middle lug grooves 321A, 321B to the outer shoulder main groove 21 are disposed to be offset in the tire circumferential direction with respect to a connection portion of the outer shoulder lug groove 311 to the outer shoulder main groove 21. Specifically, a distance D1 in the tire circumferential direction from an intersection point of an extension line of a groove center line of the outer middle lug grooves 321A, 321B and a groove center line of the outer shoulder main groove 21 to an intersection point of an extension line of a groove center line of the outer shoulder lug groove 311 and the groove center line of the outer shoulder main groove 21 is in the range 0.15≤D1/P1≤0.50, preferably in the range 0.20≤D1/P1≤0.50 with respect to the pitch length P1 of the zigzag shape of the outer shoulder main groove 21. Accordingly, pass-by noise of the tire is reduced.

The outer middle blocks 322A, 322B are defined and formed by the outer middle lug grooves 321A, 321B. In addition, edge portions of the first and second outer middle blocks 322A, 322B on the outer center main groove 22 side have a linear shape defined by the long portion of the zigzag shape of the outer center main groove 22. In addition, edge portions of the first and second outer middle blocks 322A, 322B in the tire circumferential direction, that is, edge portions defined by the first and second outer middle lug grooves 321A, 321B have a straight shape or a gentle arc shape. Accordingly, uneven wear of the block in the tread portion center region is suppressed.

As illustrated in FIG. 4, the edge portion of each of the first and second outer middle blocks 322A, 322B on the outer shoulder main groove 21 side has a zigzag shape having two bend points. Therefore, the first and second outer middle blocks 322A, 322B have a recessed hexagonal shape having a recessed portion in the edge portion on the outer shoulder main groove 21 side. Accordingly, the snow traction performance of the tire is improved. In addition, a ground contact area ratio of the first and second outer middle blocks 322A, 322B is in the range of 0.55 or more and 1.10 or less, preferably in the range of 0.70 or more and 1.05 or less. Accordingly, the ground contact areas of the outer middle blocks 322A, 322B are made uniform.

Additionally, as illustrated in FIG. 4, the outer middle blocks 322A, 322B include a plurality of sipes (reference sign omitted in drawings). As a result, the snow performance of the tire is improved.

FIG. 5 is a perspective view illustrating chamfered portions 323 of the outer middle land portion 32 illustrated in FIG. 4.

As illustrated in FIGS. 4 and 5, the outer middle land portion 32 includes the chamfered portions 323 in the edge portion on the outer shoulder main groove 21 side. The chamfered portions 323 are open to the short portion of the zigzag shape of the outer shoulder main groove 21 in a tread plan view. In the configurations of FIGS. 4 and 5, each of the chamfered portions 323 has a triangular pyramid shape having the short portion of the outer shoulder main groove 21 as one side, and connects the adjacent long portions. These chamfered portions 323 improve the snow discharge properties of the outer shoulder main groove 21 on snowy road surfaces. Additionally, in FIG. 5, a maximum depth H23 of the chamfered portions 323 with respect to the groove depth Hg1 of the outer shoulder main groove 21 is in the range 0.10≤H23/Hg1≤0.40, and is preferably in the range 0.20≤H23/Hg1≤0.30. The lower limit described above ensures the snow discharge effect by the chamfered portions 323, and the upper limit described above ensures the rigidity of the land portion.

Further, as illustrated in FIG. 3, the edge portion of the outer middle land portion 32 on the outer shoulder main groove 21 side has a zigzag shape formed by alternately connecting long portions and short portions. In addition, in FIG. 4, a circumferential length L1′ of the long portion of the zigzag shape in the edge portion on the outer shoulder main groove 21 side is in the range 0.70≤L1′/P1′≤0.95 with respect to a pitch length P1′ of the zigzag shape. In addition, the ratio L1′/P1′ is equal to the ratio L1/P1 of the zigzag shape of the outer shoulder main groove 21.

Further, as illustrated in FIG. 3, the edge portion of the outer middle land portion 32 on the outer center main groove 22 side has a zigzag shape formed by alternately connecting long portions and short portions. In addition, in FIG. 4, a circumferential length L2′ of the long portion of the zigzag shape in the edge portion on the outer center main groove 22 side is in the range 0.60≤L2′/P2′≤1.00 with respect to a pitch length P2′ of the zigzag shape. In addition, the ratio L2′/P2′ is equal to the ratio L2/P2 of the zigzag shape of the outer center main groove 22. In addition, the pitch length P2′ of the edge portion on the outer center main groove 22 side is in the range 0.40≤P2/P1′≤0.50 with respect to the pitch length P1′ of the edge portion on the outer shoulder main groove 21 side.

Additionally, as illustrated in FIG. 3, the long portion of the edge portion of the outer middle land portion 32 on the outer center main groove 22 side is inclined in an opposite direction in the tire circumferential direction with respect to the long portion of the edge portion on the outer shoulder main groove 21 side. Specifically, as illustrated in FIG. 4, the long portion of the edge portion on the outer shoulder main groove 21 side is inclined toward the tire ground contact edge T side toward the lower side in the drawing, and the long portion of the edge portion of the outer center main groove 22 side is inclined toward the tire equatorial plane CL side toward the lower side in the drawing. Therefore, the ground contact width of the outer middle land portion 32 periodically increases and decreases in the tire circumferential direction.

Additionally, in FIG. 4, a minimum ground contact width Wb2′ of the outer middle land portion 32 is in the range 0.30≤Wb2V/Wb2≤0.70 with respect to the maximum ground contact width Wb2 of the outer middle land portion 32, and is preferably in the range 0.45≤Wb2/Wb2≤0.55. Accordingly, the rigidity of the land portion in the tire circumferential direction is made uniform.

### Inner Center Main Groove

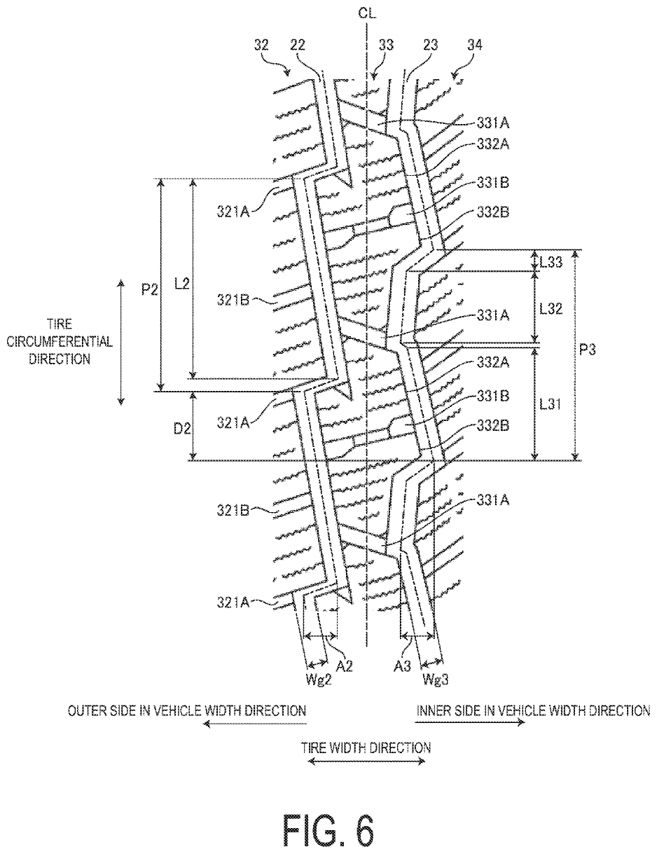

FIG. 6 is an enlarged view illustrating a tread portion center region of the tire 1 illustrated in FIG. 2. The same drawing particularly illustrates the outer and inner center main grooves 22, 23 and the center land portion 33.

As illustrated in FIG. 6, the inner center main groove 23 has a bent shape formed by connecting a first groove portion having a circumferential length L31, a second groove portion having a circumferential length L32, and a third groove portion having a circumferential length L33 (reference signs omitted in drawings). The circumferential lengths L31 to L33 of the first to third groove portions have the relationship L31>L32≥L33. Therefore, the first groove portion is defined as the groove portion having the greatest circumferential length L31. In addition, the second and third groove portions may have the same circumferential lengths L32, L33. Additionally, the inner center main groove 23 may have a short connection portion (reference sign omitted in drawings) connecting the first to third groove portions. For example, in the configuration of FIG. 6, the first and second groove portions are connected by a short connection portion having a circumferential length shorter than that of the third groove portion.

The bent shape of the main groove is defined as a shape of a groove center line of the main groove in a tread plan view.

Further, as illustrated in FIG. 6, the longest first groove portion is inclined in an opposite direction in the tire circumferential direction with respect to the other second and third groove portions. Specifically, in the configuration of FIG. 6, the first groove portion is inclined in a direction away from the tire equatorial plane CL toward the lower side in the drawing, and the second and third groove portions are inclined toward the tire equatorial plane CL side toward the lower side in the drawing. Additionally, the second and third groove portions are inclined in an identical direction with respect to the tire circumferential direction. Further, an inclination angle (dimension symbol omitted in the drawings) of the long second groove portion with respect to the tire circumferential direction is smaller than an inclination angle of the short third groove portion. In addition, the longest first groove portion of the inner center main groove 23 is inclined in an identical direction in the tire circumferential direction with respect to the long portion of the outer center main groove 22.

In the above configuration, (1) the outer center main groove 22 has the zigzag shape formed by alternately connecting the long portions and the short portions, and the inner center main groove 23 has the bent shape formed by the first to third groove portions. Therefore, edge components of the tread portion center region are ensured, and the snow performance of the tire is improved. Further, (2) the inner center main groove 23 located in the inner region in the vehicle width direction, which contributes greatly to snow performance, has a bent shape with more bend points, thereby effectively improving the snow performance of the tire. At the same time, the outer center main groove 22 located in the outer region in the vehicle width direction, where uneven wear is likely to occur, has a zigzag shape with fewer bend points, thereby ensuring the uneven wear resistance performance of the tire. Furthermore, (3) the longest first groove portion of the inner center main groove 23 is inclined in an identical direction in the tire circumferential direction with respect to the long portion of the outer center main groove 22, whereby the rigidity of the center land portion 33 is made uniform in the tire circumferential direction, and uneven wear of the center land portion 33 is suppressed.

In addition, in FIG. 6, the circumferential length L31 of the first groove portion of the inner center main groove 23 is in the range 0.35≤L31/P3≤0.75, preferably in the range 0.50≤L31/P3≤0.60, with respect to a pitch length P3 of the bent shape of the inner center main groove 23. The lower limit described above ensures the circumferential length L31 of the long first groove portion, thereby ensuring the effect of improving snow discharge properties on snowy road surfaces. The upper limit described above ensures edge components of the short second and third groove portions, thereby ensuring the snow traction properties of the tire.

Further, in FIG. 6, the circumferential length L32 of the second groove portion of the inner center main groove 23 is in the range 0.20≤L32/P3≤0.45 with respect to the pitch length P3 of the bent shape of the inner center main groove 23, preferably in the range 0.30≤L32/P3≤0.40. Accordingly, the circumferential length L32 of the short second groove portion is properly set.

Further, in FIG. 6, the circumferential length L33 of the third groove portion of the inner center main groove 23 is in the range 0.05≤L33/P3 with respect to the pitch length P3 of the bent shape of the inner center main groove 23, and preferably in the range 0.08≤L33/P3. Further, an inclination angle of the third groove portion with respect to the tire circumferential direction is greater than those of the first and second groove portions and is in the range of 40 degrees or more and 90 degrees or less. Additionally, the inclination angle of the third groove portion with respect to the tire circumferential direction is preferably greater than an inclination angle of the second groove portion by 30 degrees or more. Accordingly, edge components of the short third groove portion are ensured, thereby ensuring the snow traction properties of the tire. The upper limit of the ratio L33/P3 is not limited to a particular value but is subject to restrictions by the circumferential lengths L31 to L33 of the first to third groove portions having the relationship L31>L32≥L33.

Further, in the configuration of FIG. 6, the third groove portion of the inner center main groove 23 is disposed to be offset in the tire circumferential direction with respect to the short portion of the outer center main groove 22. Specifically, as illustrated in FIG. 6, the third groove portion of the inner center main groove 23 is inclined in an identical direction in the tire circumferential direction with respect to the short portion of the outer center main groove 22, and both are arranged in a staggered manner in the tire circumferential direction. Further, the phase between the third groove portion of the inner center main groove 23 and the short portion of the outer center main groove 22, that is, a circumferential distance D2 is in the range 0.30≤D2/P2≤0.70 with respect to the pitch length P2 of the zigzag shape of the outer center main groove 22, preferably in the range 0.40≤D2/P2≤0.60. Due to this, uneven wear in the tread portion center region is suppressed.

Further, in the configuration of FIG. 6, a groove width (dimension symbol omitted in the drawings) of the second groove portion of the inner center main groove 23 is greater than groove widths of the other first and third groove portions. Specifically, the groove width of the second groove portion is in the range of 65% or more and 95% or less with respect to the groove width of the third groove portion, and preferably in the range of 75% or more and 85% or less. The configuration described above is preferable in that the snow discharge properties of the shortest third groove portion on snowy road surfaces are improved. Specifically, however, no such limitation is intended, and the first to third groove portions may have the same groove width (not illustrated).

Further, in FIG. 6, the pitch length P3 of the bent shape of the inner center main groove 23 is in the range 0.80≤P3/P2≤1.20 with respect to the pitch length P2 of the zigzag shape of the outer center main groove 22, and preferably in the range of 0.95≤P3/P2≤1.05. The range of the ratio P3/P2 indicates a range of non-uniformity of the pitch lengths P2, P3 in each pitch. Therefore, the pitch length P3 of the inner center main groove 23 is set to be substantially equal to the pitch length P2 of the outer center main groove 22. Accordingly, the rigidity of the tread portion center region is made uniform, thereby suppressing uneven wear of the tire. Further, a pitch number N3 of the bent shape of the inner center main groove 23 is in the range 30≤N3≤50. Further, in the configuration of FIG. 6, the pitch number N3 of the inner center main groove 23 is set such that N3/N2=1 with respect to the pitch number N2 of the outer center main groove 22.

In addition, in FIG. 6, an amplitude A3 of the bent shape of the inner center main groove 23 is in the range 0.55≤A3/Wg3≤0.95 with respect to a groove width Wg3 of the inner center main groove 23, and preferably in the range 0.70≤A3/Wg3≤0.90. The lower limit described above ensures the effect of improving snow traction performance by the bent shape, and the upper limit described above suppresses generation of uneven wear due to excessive enlargement of the amplitude.

Further, in FIG. 6, the amplitude A3 of the bent shape of the inner center main groove 23 is in the range 0.80≤A3/A2≤1.20 with respect to the amplitude A2 of the zigzag shape of the outer center main groove 22, and preferably in the range 0.95≤A3/A2≤1.05. Therefore, the amplitude A3 of the inner center main groove 23 is substantially the same as the amplitude A2 of the outer center main groove 22. Accordingly, the rigidity of the tread portion center region is made uniform, thereby improving the uneven wear resistance of the tire.

In addition, in FIG. 6, the groove width Wg3 of the inner center main groove 23 is in the range 4.0 mm≤Wg3≤12.0 mm, and a groove depth Hg3 (see FIG. 8 described below) is in the range 8.0 mm≤Hg3≤12.0 mm. The lower limit described above ensures the groove volume of the inner center main groove 23, thus ensuring the snow performance of the tire, and the upper limit described above ensures the rigidity of the tread portion center region, thus ensuring the uneven wear resistance performance of the tire.

Further, in FIG. 6, the groove width Wg3 of the inner center main groove 23 is in the range 0.80≤Wg3/Wg2≤1.20 with respect to the groove width Wg2 of the outer center main groove 22, and preferably in the range 0.95≤Wg3/Wg2≤1.05. Therefore, the groove width Wg3 of the inner center main groove 23 is substantially the same as the groove width Wg2 of the outer center main groove 22. Accordingly, the rigidity of the tread portion center region is made uniform, thereby improving the uneven wear resistance of the tire.

Further, in the configuration of FIG. 6, the groove width (dimension symbol omitted in the drawings) of the second groove portion having the circumferential length L32 is greater than groove widths of the other first and third groove portions. The configuration described above is preferable in that the snow discharge performance and the uneven wear resistance performance are provided in a compatible manner. However, no such limitation is intended, and the first to third groove portions of the inner center main groove 23 may have a uniform groove width (not illustrated).

Further, in the configuration of FIG. 6, the inner center main groove 23 has a see-through-less structure in the tire circumferential direction. In other words, the groove width Wg3 and the amplitude A3 of the inner center main groove 23 is set such that edge portions of the left and right land portions 33, 34 defined by the inner center main groove 23 overlap each other as viewed in the tire circumferential direction.

### Center Land Portion

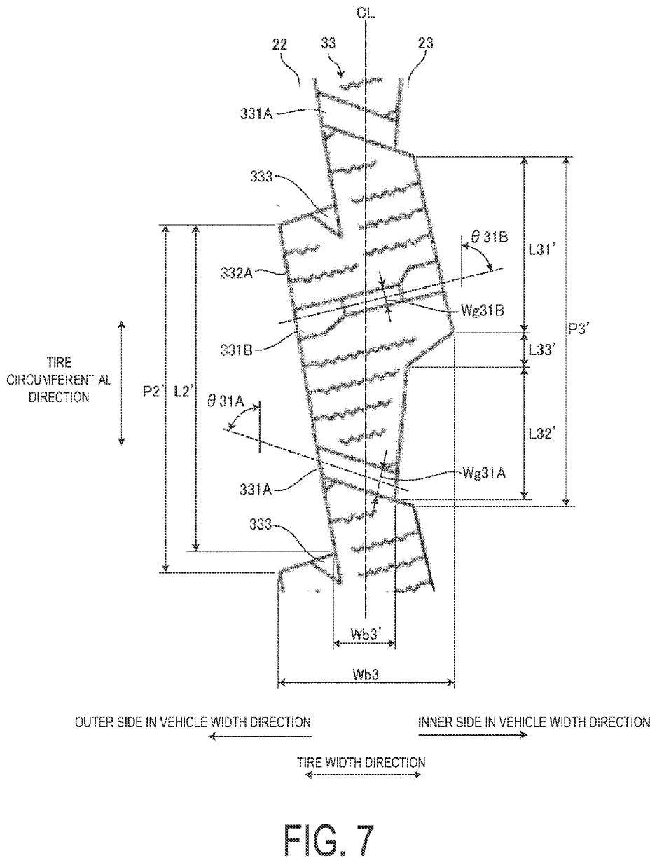

FIG. 7 is an enlarged view illustrating the center land portion 33 illustrated in FIG. 6. FIG. 8 is a cross-sectional view in a groove length direction illustrating a second center lug groove 331B of the center land portion 33 illustrated in FIG. 7.

As illustrated in FIG. 6, the center land portion 33 includes a first center lug groove 331A and the second center lug groove 331B, and a first center block 332A and a second center block 332B.

The first and second center lug grooves 331A, 331B have a straight shape or a gentle arc shape, extend through the center land portion 33 in the tire width direction, and are connected to the outer center main groove 22 and the inner center main groove 23. The first and second center lug grooves 331A, 331B are inclined in mutually opposite directions with respect to the tire circumferential direction. This improves the snow traction properties in the center land portion 33. In addition, the short first center lug groove 331A is inclined in the opposite direction in the tire circumferential direction with respect to the outer middle lug grooves 321A, 321B described above and inner middle lug grooves 341A, 341B described below, and the long second center lug groove 331B is inclined in an identical direction in the tire circumferential direction with respect to the outer middle lug grooves 321A, 321B and the inner middle lug grooves 341A, 341B.

However, no such limitation is intended, and the short first center lug groove 331A may be inclined in an identical direction in the tire circumferential direction with respect to the outer middle lug grooves 321A, 321B and the inner middle lug grooves 341A, 341B, and the long second center lug groove 331B may be inclined in the opposite direction in the tire circumferential direction with respect to the outer middle lug grooves 321A, 321B and the inner middle lug grooves 341A, 341B (not illustrated).

In addition, in FIG. 6, the above-described outer center main groove 22 and the inner center main groove 23 described below have a zigzag shape and a bent shape which are mutually asymmetrical, so that the ground contact width of the center land portion 33 periodically increases and decreases in the tire circumferential direction. In addition, the first center lug groove 331A is disposed in a region where the ground contact width of the center land portion 33 decreases, and the second center lug groove 331B is disposed in a region where the ground contact width of the center land portion 33 increases. Accordingly, the first center lug groove 331A is shorter than the second center lug groove 331B.

Specifically, one end portion of each of the first and second center lug grooves 331A, 331B is connected to a central portion of the long portion of the zigzag shape of the outer center main groove 22 while being spaced apart from a maximum amplitude position of the zigzag shape of the outer center main groove 22. Further, the other end of the first center lug groove 331A is connected to a maximum amplitude position of the bent shape of the inner center main groove 23 toward the tire equatorial plane CL side. On the other hand, the other end portion of the second center lug groove 331B is connected to a central portion of the long portion of the zigzag shape while being spaced apart from the maximum amplitude position of the bent shape of the inner center main groove 23.

In addition, in FIG. 6, a groove width Wg31 (Wg31A, Wg31B; see FIG. 7) of the first and second center lug grooves 331A, 331B is in the range 0.30≤Wg31/Wg2≤0.90 with respect to the groove width Wg2 of the long portion of the outer center main groove 22, and preferably in the range 0.55≤Wg31/Wg2≤0.85. Additionally, the groove width Wg31 of the center lug grooves 331A, 331B is in the range 2.0 mm≤Wg31≤7.0 mm. Further, in FIG. 7, an inclination angle θ31 (θ31A, θ31B) of the first and second center lug grooves 331A, 331B is in the range 50°≤θ31≤90°.

Further, in the configuration of FIG. 6, the first center lug groove 331A extends so as to extend a groove wall of a connection portion between the first groove portion and the second groove portion of the inner center main groove 23 in the tire width direction. Specifically, as illustrated in FIG. 7, one groove wall (lower side in the drawing) of the first center lug groove 331A on the inner center main groove 23 side is connected flush with a groove wall of the connecting portion between the first groove portion and the second groove portion of the inner center main groove 23. Accordingly, a corner portion of the first center block 332A described below has an obtuse V-shape defined by the first center lug groove 331A and the long portion of the inner center main groove 23.

Further, as illustrated in FIG. 7, the first center lug groove 331A includes a widened portion (reference sign omitted in drawings) at connection portions with respect to the outer center main groove 22 and the inner center main groove 23. Additionally, the second center lug groove 331B includes a chamfered portion (reference sign omitted in the drawings) at connection portions with respect to the outer center main groove 22 and the inner center main groove 23. As a result, the snow discharge properties of the first center lug groove 331A, the outer center main groove 22, and the inner center main groove 23 are improved.

Further, as illustrated in FIG. 8, the second center lug groove 331B includes a raised bottom portion 3311 at a central portion of the center land portion 33. This ensures the rigidity of the center land portion 33. Additionally, a depth H311 from a road contact surface of the center land portion 33 to a top surface of the raised bottom portion 3311 is in the range 0.60≤H311/H31≤0.90 with respect to a maximum groove depth H31 of the second center lug groove 331B. Furthermore, the maximum groove depth H31 of the second center lug groove 331B is in the range of 65% or more and 95% or less with respect to the (maximum) groove depth Hg2 of the outer center main groove 22 and the (maximum) groove depth Hg3 of the inner center main groove 23.

The center blocks 332A, 332B are defined and formed by the center lug grooves 331A, 331B. In addition, an edge portion of the first center block 332A on the outer center main groove 22 side has a zigzag shape having two bend points, and the edge portion of the inner center main groove 23 has an obtuse V shape defined by the first center lug groove 331A and the long portion of the inner center main groove 23 as described above. In addition, an edge portion of the second center block 332B on the outer center main groove 22 side has a straight shape, and the edge portion of the inner center main groove 23 has a zigzag shape having two bend points. Therefore, each of the first and second center blocks 332A, 332B has a recessed hexagonal shape having a recessed portion in the edge portion on the outer center main groove 22 side or the inner center main groove 23 side as a whole. Accordingly, the snow traction performance of the tire is improved. In addition, a ground contact area ratio of the first and second center blocks 332A, 332B is in the range of 0.80 or more and 1.20 or less, preferably in the range of 0.85 or more and 1.15 or less. Accordingly, the ground contact areas of the center blocks 332A, 332B are made uniform.

Additionally, as illustrated in FIG. 7, the center blocks 332A, 332B include a plurality of sipes (reference sign omitted in drawings). As a result, the snow performance of the tire is improved.

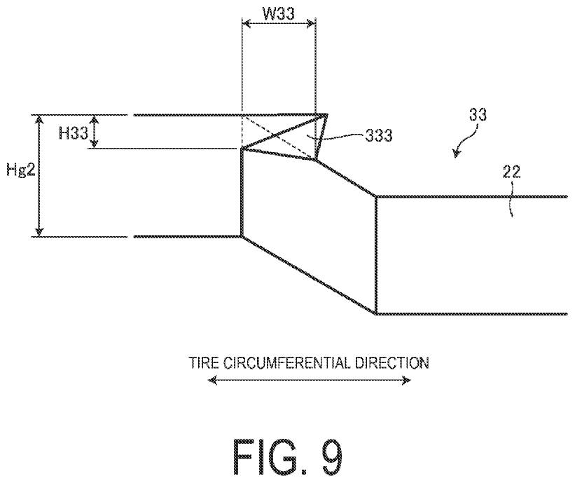

FIG. 9 is a perspective view illustrating a chamfered portion 333 of the center land portion 33 illustrated in FIG. 7.

As illustrated in FIG. 7, the center land portion 33 includes the chamfered portion 333 in the edge portion on the outer center main groove 22 side. As illustrated in FIGS. 7 and 9, the chamfered portion 333 has a triangular pyramid shape with the short portion of the zigzag shape on the outer center main groove 22 side as one side in a tread plan view, and connects adjacent long portions. These chamfered portions 333 improve the snow discharge properties of the outer center main groove 22 on snowy road surfaces. Additionally, in FIG. 9, a maximum depth H33 of the chamfered portion 333 is in the range 0.10≤H33/Hg2≤0.40 with respect to the groove depth Hg2 of the outer center main groove 22, and is preferably in the range 0.20≤H33/Hg2≤0.30. The lower limit described above ensures the snow discharge effect by the chamfered portion 333, and the upper limit described above ensures the rigidity of the land portion.

Further, as illustrated in FIG. 6, the edge portion of the center land portion 33 on the outer center main groove 22 side has a zigzag shape formed by alternately connecting long portions and short portions. In addition, in FIG. 7, the circumferential length L2′ of the long portion of the zigzag shape in the edge portion on the outer center main groove 22 side is in the range 0.60≤L2′/P2′≤1.00 with respect to the pitch length P2′ of the zigzag shape. In addition, the ratio L2′/P2′ is equal to the ratio L2/P2 of the zigzag shape of the outer center main groove 22.

Further, as illustrated in FIG. 6, an edge portion of the center land portion 33 on the inner center main groove 23 side has a bent shape formed by connecting the first to third groove portions. Further, in FIG. 7, a circumferential length L31′ of the edge portion defined by the first groove portion is in the range 0.30≤L31′/P3′≤0.80 with respect to a pitch length P3′ of the bent shape. Further, the ratio L31′/P3′ is equal to the ratio L31/P3 of the bent shape of the inner center main groove 23. In addition, the pitch length P3′ of the edge portion on the inner center main groove 23 side is in the range 0.80≤P3/P2′≤1.20 with respect to the pitch length P2′ of the edge portion on the outer center main groove 22 side.

Additionally, as illustrated in FIG. 6, the longest edge portion of the center land portion 33 on the inner center main groove 23 side (the edge portion defined by the first groove portion of the inner center main groove 23) is inclined in an identical direction in the tire circumferential direction with respect to the long portion of the edge portion on the outer center main groove 22 side. On the other hand, the outer center main groove 22 and the inner center main groove 23 have a zigzag shape and a bent shape which are mutually asymmetrical, so that the ground contact width of the center land portion 33 periodically increases and decreases in the tire circumferential direction, as illustrated in FIG. 7.

Additionally, in FIG. 7, a minimum ground contact width Wb3′ of the center land portion 33 is in the range 0.20≤Wb3′/Wb3≤0.50 with respect to the maximum ground contact width Wb3 of the center land portion 33, and is preferably in the range 0.25≤Wb3′/Wb3≤0.35. Accordingly, the rigidity of the land portion in the tire circumferential direction is made uniform.

### Inner Shoulder Main Groove

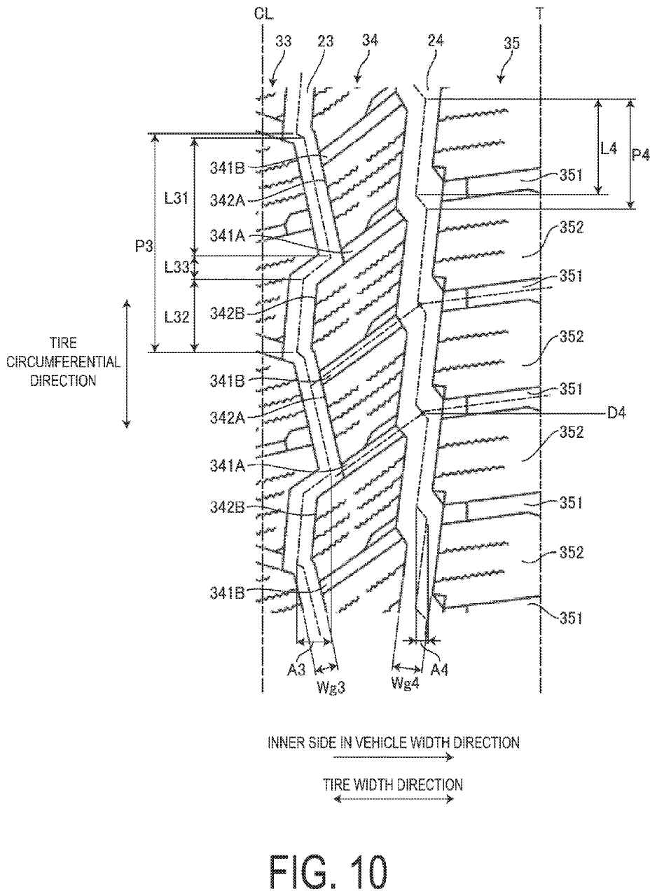

FIG. 10 is an enlarged view illustrating the inner region in the vehicle width direction of the tire 1 illustrated in FIG. 2. The same drawing illustrates a ground contact region on the inner side in the vehicle width direction demarcated by the tire equatorial plane CL.

As illustrated in FIG. 10, the inner shoulder main groove 24 has a zigzag shape made by alternately connecting long portions and short portions. Further, the long portion of the inner shoulder main groove 24 is inclined in the opposite direction in the tire circumferential direction with respect to the longest first groove portion (the groove portion having the circumferential length L31) of the inner center main groove 23. Specifically, in the configuration of FIG. 10, the long portion of the inner shoulder main groove 24 is inclined toward the tire equatorial plane CL side toward the lower side in the drawing, and the first groove portion of the inner center main groove 23 is inclined toward the tire ground contact edge T side toward the lower side in the drawing.

In the above-described configuration, (1) the inner shoulder main groove 24 and the inner center main groove 23 have a zigzag shape or a bent shape having a long portion or a long groove portion. Therefore, compared to a configuration (not illustrated) in which the main groove has a zigzag shape formed by connecting groove portions having the same length, snow discharge properties on snowy road surfaces are improved, and snow performance of the tire is improved. Further, (2) the long portion of the inner shoulder main groove 24 and the long first groove portion of the inner center main groove 23 are inclined in mutually opposite directions with respect to the tire circumferential direction. Therefore, the edge components are increased and the snow traction performance of the tire is ensured as compared with a configuration (not illustrated) in which both are inclined in an identical direction with respect to the tire circumferential direction.

Additionally, in FIG. 10, a circumferential length L4 of the long portion of the inner shoulder main groove 24 is in the range 0.70≤L4/P4≤0.95 with respect to a pitch length P4 of the zigzag shape of the inner shoulder main groove 24, and is preferably in the range 0.80≤L4/P4≤0.90. The lower limit described above ensures the effect of improving snow discharge properties on snowy road surfaces due to the zigzag shape having the long portion, and the upper limit described above ensures the length of the short portion, thereby ensuring snow traction properties of the tire.

In addition, in FIG. 10, the pitch length P4 of the zigzag shape of the inner shoulder main groove 24 and the pitch length P3 of the bent shape of the inner center main groove 23 have the relationship 0.35≤P3/P4≤0.65, preferably the relationship 0.40≤P3/P4≤0.50. Therefore, the pitch length P3 of the inner center main groove 23 is long, and the pitch length P4 of the inner shoulder main groove 24 is short. As a result, the rigidity of the tread portion center region is ensured, thereby suppressing uneven wear of the tire, and edge components of the tread portion shoulder region are ensured, thereby ensuring the snow traction performance of the tire. Further, a pitch number N4 of the zigzag shape of the inner shoulder main groove 24 is in the range 30≤N4≤50. Further, in the configuration of FIG. 10, the pitch number N4 of the inner shoulder main groove 24 and the pitch number N3 of the inner center main groove 23 have the relationship N3/N4=1/2.

Additionally, in FIG. 10, an amplitude A4 of the zigzag shape of the inner shoulder main groove 24 is in the range 0.20≤A4/Wg4≤0.50 with respect to a groove width Wg4 of the inner shoulder main groove 24, and preferably in the range 0.30≤A4/Wg4≤0.40. The lower limit described above ensures the effect of improving snow traction performance by the zigzag shape, and the upper limit described above suppresses generation of uneven wear due to excessive enlargement of the amplitude.

In addition, in FIG. 10, the amplitude A4 of the zigzag shape of the inner shoulder main groove 24 and the amplitude A3 of the bent shape of the inner center main groove 23 have the relationship 0.30≤A4/A3≤0.60, preferably the relationship 0.40≤A4/A3≤0.50. Therefore, the amplitude A3 of the inner center main groove 23 is larger than the amplitude A4 of the inner shoulder main groove 24. As a result, edge components are increased and the snow traction properties of the tire are ensured as compared with a configuration (not illustrated) in which both have substantially the same amplitude.

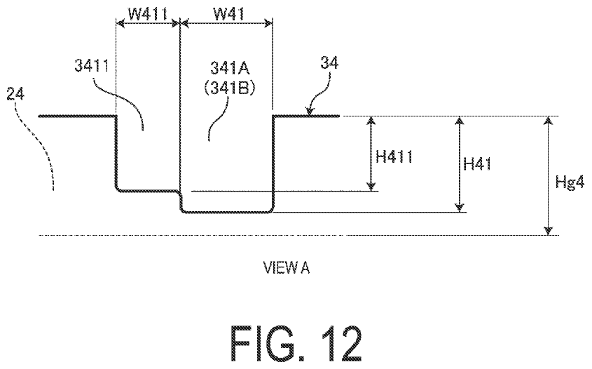

In addition, in FIG. 10, the groove width Wg4 of the inner shoulder main groove 24 is in the range 8.0 mm≤Wg4≤15.0 mm, and a groove depth Hg4 (see FIG. 12 described below) is in the range 8.0 mm≤Hg4≤12.0 mm.

In addition, in FIG. 10, the groove width Wg4 of the inner shoulder main groove 24 and the groove width Wg3 of the inner center main groove 23 have the relationship 0.50≤Wg3/Wg4≤0.90, preferably the relationship 0.60≤Wg3/Wg4≤0.80. Therefore, the groove width Wg3 of the inner center main groove 23 is smaller than the groove width Wg4 of the inner shoulder main groove 24. Accordingly, the snow performance of the tire is improved compared with a configuration (not illustrated) where both have approximately the same groove width.

In the configuration of FIG. 10, the inner shoulder main groove 24 has a see-through structure in the tire circumferential direction. In other words, the groove width Wg4 and the amplitude A4 of the inner shoulder main groove 24 are ensured such that edge portions of the left and right land portions 34, 35 defined by the inner shoulder main groove 24 do not overlap each other as viewed in the tire circumferential direction.

Further, as illustrated in FIG. 2, the long portion of the inner shoulder main groove 24 is inclined in an identical direction in the tire circumferential direction with respect to the long portion of the outer shoulder main groove 21. Further, the inner shoulder main groove 24 has a point symmetrical structure with respect to the outer shoulder main groove 21.

Further, in FIG. 2, the pitch length P4 (see FIG. 10) of the zigzag shape of the inner shoulder main groove 24 is in the range 0.80≤P4/P1≤1.20, and preferably in the range of 0.95≤P4/P1≤1.05, with respect to the pitch length P1 (see FIG. 3) of the zigzag shape of the outer shoulder main groove 21. Therefore, the pitch length P4 of the inner shoulder main groove 24 is set to be substantially equal to the pitch length P1 of the outer shoulder main groove 21. Further, in the configuration of FIG. 10, the pitch number N4 of the inner shoulder main groove 24 is also equal to the pitch number N1 of the outer shoulder main groove 21, and N4/N1=1.0.

Further, in FIG. 2, the amplitude A4 of the zigzag shape of the inner shoulder main groove 24 (see FIG. 10) and the amplitude A1 of the zigzag shape of the outer shoulder main groove 21 (see FIG. 3) have the relationship 0.80≤A4/A1≤1.20, preferably the relationship 0.95≤A4/A1≤1.05. Therefore, the amplitude A4 of the inner shoulder main groove 24 is substantially equal to the amplitude A1 of the outer shoulder main groove 21. Accordingly, the rigidity of the left and right shoulder regions is made uniform.

Further, in FIG. 2, the groove width Wg4 of the inner shoulder main groove 24 (see FIG. 10) and the groove width Wg1 of the outer shoulder main groove 21 (see FIG. 3) have the relationship 0.80≤Wg4/Wg1≤1.20, preferably the relationship 0.95≤Wg4/Wg1≤1.05. Therefore, the groove width Wg4 of the inner shoulder main groove 24 is substantially equal to the groove width Wg1 of the outer shoulder main groove 21. Accordingly, the rigidity of the left and right shoulder regions is made uniform.

### Inner Middle Land Portion

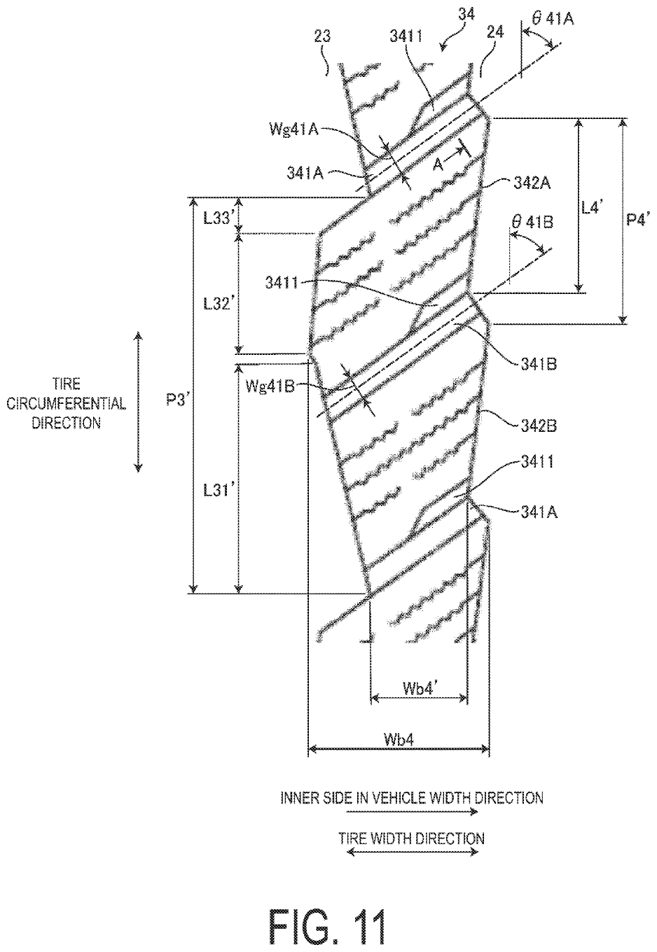

FIG. 11 is an enlarged view illustrating the inner middle land portion 34 illustrated in FIG. 10.

As illustrated in FIG. 10, the inner middle land portion 34 includes the first inner middle lug groove 341A and the second inner middle lug groove 341B, and a first inner middle block 342A and a second inner middle block 342B.

The first and second inner middle lug grooves 341A, 341B have a straight shape or a gentle arc shape, extend through the inner middle land portion 34 in the tire width direction, and are connected to the inner center main groove 23 and the inner shoulder main groove 24. The first and second inner middle lug grooves 341A, 341B are inclined in an identical direction with respect to the tire circumferential direction. The first and second inner middle lug grooves 341A, 341B are inclined in an identical direction in the tire circumferential direction with respect to the first and second outer middle lug grooves 321A, 321B.

Additionally, the first inner middle lug groove 341A includes one end portion connected to a maximum amplitude position toward the tire ground contact edge T side of the bent shape of the inner center main groove 23, and the other end portion connected to a maximum amplitude position toward the tire equatorial plane CL side of the zigzag shape of the inner shoulder main groove 24. Additionally, the second inner middle lug groove 341B includes one end portion connected to a position spaced apart from the maximum amplitude position of the bent shape of the inner center main groove 23, and the other end portion connected to the maximum amplitude position toward the tire equatorial plane CL side of the zigzag shape of the inner shoulder main groove 24. In addition, the first and second inner middle lug grooves 341A, 341B each connect to the long first groove portion of the bent shape of the inner center main groove 23 at one end portion and connect to the short portion of the zigzag shape of the inner shoulder main groove 24 at the other end portion.

In addition, in FIG. 10, a groove width W41 (Wg41A, Wg41B; see FIG. 11) of the first and second inner middle lug grooves 341A, 341B is in the range 0.40≤W41/Wg3≤0.80 with respect to the groove width Wg3 of the inner center main groove 23, and preferably in the range 0.55≤W41/Wg3≤0.65. Additionally, the groove width W41 of the inner middle lug grooves 341A, 341B is in the range 2.0 mm≤W41≤6.0 mm.

Further, as illustrated in FIG. 10, the first and second inner middle lug grooves 341A, 341B are inclined in an identical direction in the tire circumferential direction with respect to the long portion of the zigzag shape of the inner shoulder main groove 24. Further, in FIG. 11, an inclination angle θ41 (θ41A, θ41B) of the first and second inner middle lug grooves 341A, 341B is in the range 40°≤θ41≤70°.

Further, in the configuration of FIG. 10, the first inner middle lug groove 341A extends so as to extend the short third groove portion of the bent shape of the inner center main groove 23 in the tire width direction. Specifically, as illustrated in FIG. 11, one groove wall (lower side in the drawing) of the first inner middle lug groove 341A on the inner center main groove 23 side is connected flush with a groove wall of the third groove portion of the inner center main groove 23. Accordingly, the snow discharge properties of the inner center main groove 23 and the first inner middle lug groove 341A are improved.

Further, as illustrated in FIG. 10, a connection portion of the inner middle lug grooves 341A, 341B to the inner shoulder main groove 24 are disposed at substantially the same positions in the tire circumferential direction as a connection portion of an inner shoulder lug groove 351 (described below) to the inner shoulder main groove 24. Specifically, a distance D4 in the tire circumferential direction from an intersection point of an extension line of a groove center line of the inner middle lug grooves 341A, 341B and a groove center line of the inner shoulder main groove 24 to an intersection point of an extension line of a groove center line of the inner shoulder lug groove 351 and the groove center line of the inner shoulder main groove 24 is in the range 0≤D4/P4<0.15, preferably in the range 0≤D4/P4<0.10 with respect to the pitch length P4 of the zigzag shape of the inner shoulder main groove 24. As a result, snow discharge properties on snowy road surfaces are improved.

The inner middle blocks 342A, 342B are defined and formed by the inner middle lug grooves 341A, 341B. In addition, a ground contact area ratio of the first and second inner middle blocks 342A, 342B is in the range of 0.80 or more and 1.20 or less, preferably in the range of 0.85 or more and 1.15 or less. Accordingly, ground contact areas of the inner middle blocks 342A, 342B are made uniform.

Additionally, as illustrated in FIG. 11, the inner middle blocks 342A, 342B include a plurality of sipes (reference sign omitted in drawings). As a result, the snow performance of the tire is improved.

FIG. 12 is a cross-sectional view illustrating a notch portion 3411 of the inner middle lug grooves 341A, 341B illustrated in FIG. 11. The same drawing illustrates a cross-sectional view of the inner middle lug grooves 341A, 341B in the groove width direction.

As illustrated in FIG. 11, each of the inner middle lug grooves 341A, 341B have the notch portion 3411 in a connection portion on the inner shoulder main groove 24 side. As illustrated in FIG. 11, the notch portions 3411 extend in the groove length direction of the inner middle lug grooves 341A, 341B in a tread plan view, and are open to an edge portion of the inner middle land portion 34 on the inner shoulder main groove 24 side. Additionally, an extension length (dimension symbol omitted in the drawings) of the notch portion 3411 is in the range of 0.40% or more and 0.80% or less with respect to the groove length of the inner middle lug grooves 341A, 341B. As a result, the groove volume of the inner middle lug grooves 341A, 341B is increased, and the snow discharge properties of the inner middle lug grooves 341A, 341B on snowy road surfaces are improved.

In addition, as illustrated in FIG. 12, a width W411 of the notch portion 3411 is in the range 0.50≤W411/W41≤0.80 with respect to the groove width W41 of the inner middle lug grooves 341A, 341B, and is preferably in the range 0.60≤W411/W41≤0.70. In addition, a maximum depth H411 of the notch portion 3411 is in the range 0.50≤H411/H41≤0.90 with respect to the groove depth H41 of the inner middle lug grooves 341A, 341B, and is preferably in the range 0.70≤H411/H41≤0.80. The lower limit described above ensures the snow discharge effect by the notch portion 3411, and the upper limit described above ensures the rigidity of the land portion. Further, as illustrated in FIG. 11, an edge portion of the inner middle land portion 34 on the inner center main groove 23 side has a bent shape formed by connecting first to third liner portions. Further, in FIG. 4, a circumferential length L31′ of the longest linear portion of the edge portion on the inner center main groove 23 side is in the range 0.35≤L31′/P3′≤0.60 with respect to the pitch length P3′ of the bent shape. Further, the ratio L31′/P3′ is equal to a ratio L31/P3 of the bent shape of the inner center main groove 23.

Further, as illustrated in FIG. 11, the edge portion of the inner middle land portion 34 on the inner shoulder main groove 24 side has a zigzag shape formed by alternately connecting long portions and short portions. In addition, in FIG. 11, a circumferential length L4′ of the long portion of the zigzag shape in an edge portion on the inner shoulder main groove 24 side is in the range 0.80≤L4′/P4′≤0.90 with respect to a pitch length P4′ of the zigzag shape. In addition, a ratio L4/P4′ is equal to the ratio L4/P4 of the zigzag shape of the inner shoulder main groove 24. In addition, the pitch length P4′ of the edge portion on the inner shoulder main groove 24 side has the relationship 0.35≤P3′/P4′≤0.65 with respect to the pitch length P3′ of the edge portion on the inner center main groove 23 side.

Additionally, as illustrated in FIG. 11, the longest linear portion of the edge portion of the inner middle land portion 34 on the inner center main groove 23 side is inclined in an opposite direction in the tire circumferential direction with respect to the long portion of the edge portion on the inner shoulder main groove 24 side. Specifically, as illustrated in FIG. 10, the longest linear portion of the edge portion on the inner center main groove 23 side is inclined toward the tire ground contact edge T side toward the lower side in the drawing, and the long portion of the edge portion on the inner shoulder main groove 24 side is inclined toward the tire equatorial plane CL side toward the lower side in the drawing. Therefore, the ground contact width of the inner middle land portion 34 periodically increases and decreases in the tire circumferential direction.

Additionally, in FIG. 11, a minimum ground contact width Wb4′ of the inner middle land portion 34 is in the range 0.30≤Wb4/Wb4≤0.70 with respect to the maximum ground contact width Wb4 of the inner middle land portion 34, and is preferably in the range 0.45≤Wb47/Wb4≤0.55. Accordingly, the rigidity of the land portion in the tire circumferential direction is made uniform.

### Inner Shoulder Land Portion

As illustrated in FIG. 10, the inner shoulder land portion 35 includes inner shoulder lug grooves 351 and inner shoulder blocks 352.

The inner shoulder lug grooves 351 have a straight shape or a gentle arc shape, extends through the inner shoulder land portion 35 in the tire width direction, and is connected to the tire ground contact edge T and the inner shoulder main groove 24. Additionally, the inner shoulder lug grooves 351 are connected to an end portion of the long portion of the zigzag shape of the inner shoulder main groove 24, and is connected to a maximum amplitude position toward the tire ground contact edge T side of the zigzag shape of the inner shoulder main groove 24. Further, the inner shoulder main groove 24 has a raised bottom portion (reference sign omitted in drawings) at an opening portion on the inner shoulder main groove 24 side. Additionally, a plurality of the inner shoulder lug grooves 351 are arrayed at a predetermined interval in the tire circumferential direction. Additionally, a groove width Wg51 (dimension symbol omitted in the drawings) of the inner shoulder lug grooves 351 is in the range of 5.0 mm or more and 10.0 mm or less, and a groove depth Hg51 of the inner shoulder lug grooves 351 is in the range of 6.0 mm or more and 11.0 mm or less.

The inner shoulder blocks 352 are defined and formed by the plurality of inner shoulder lug grooves 351. Additionally, an edge portion of the inner shoulder blocks 352 on the inner shoulder main groove 24 side is defined and formed by a pair of the long portion and the short portion of the inner shoulder main groove 24 and has a V shape projecting toward the tire equatorial plane CL side. This ensures the rigidity of the blocks and suppresses uneven wear of the tire.

Additionally, as illustrated in FIG. 10, the inner shoulder blocks 352 each include a plurality of sipes (reference sign omitted in drawings). As a result, the snow performance of the tire is improved.

### Effects

As described above, [1] a tire 1 includes a plurality of main grooves 21 to 24 extending in a tire circumferential direction, and a plurality of land portions 31 to 35 defined and formed by the plurality of main grooves 21 to 24 (see FIG. 2). Additionally, the plurality of main grooves 21 to 24 includes a first center main groove 23 and a second center main groove 24 adjacent to each other with a tire equatorial plane CL interposed between the first center main groove 23 and the second center main groove 24. Further, the plurality of land portions 31 to 35 includes a center land portion 33 defined and formed by the first center main groove 23 and the second center main groove 24. Further, the first center main groove (the outer center main groove) 22 has a zigzag shape formed by alternately connecting a long portion and a short portion (see FIG. 6). Further, the second center main groove (the inner center main groove) 23 has a bent shape formed by connecting a first groove portion having a circumferential length L31, a second groove portion having a circumferential length L32, and a third groove portion having a circumferential length L33. The circumferential lengths L31 to L33 of the first groove portion to the third groove portion have a relationship L31>L32≥L33.

In the above configuration, (1) the first center main groove 22 has the zigzag shape formed by alternately connecting the long portions and the short portions, and the second center main groove 23 has the bent shape formed by the first to third groove portions. Therefore, edge components of the tread portion center region are ensured, and the snow performance of the tire is improved. Further, (2) when the first center main groove 22 is located in an outer region in the vehicle width direction and the second center main groove 23 is located in an inner region in the vehicle width direction in a state where the tire is mounted on a vehicle, the uneven wear resistance performance of the tire is ensured by the first center main groove 22 having a zigzag shape with fewer bend points, and the snow performance of the tire is effectively enhanced by the second center main groove 23 having a bent shape with more bend points. This has the advantage of providing the snow performance of the tire and the uneven wear resistance performance of the tire in a compatible manner. Further, [2] in the tire 1 according to [1] described above, a circumferential length L2 of the long portion of the first center main groove 22 is in a range 0.60≤L2/P2≤1.00 with respect to a pitch length P2 of the zigzag shape of the first center main groove 22 (see FIG. 6). This has the advantage that the lower limit described above ensures the effect of improving snow discharge properties on snowy road surfaces due to the zigzag shape having the long portion, and the upper limit described above ensures the length of the short portion, thereby ensuring snow traction properties of the tire.

Further, [3] in the tire 1 according to [1] or [2] described above, an amplitude A2 of the zigzag shape of the first center main groove 22 is in a range 1.40≤A2/Wg2≤1.90 with respect to a groove width Wg2 of the first center main groove 22 (see FIG. 6). This has the advantage that the lower limit described above ensures an effect of improving snow traction performance by the zigzag shape, and the upper limit described above suppresses generation of uneven wear due to excessive enlargement of the amplitude.

Further, [4] in the tire 1 according to any one of [1] to [3] described above, the first groove portion of the second center main groove 23, and the second groove portion and the third groove portion of the second center main groove 23 are inclined in mutually opposite directions in the tire circumferential direction (see FIG. 6). This has the advantage that the bent shape of the second center main groove 23 is properly set.

Further, [5] in the tire 1 according to any one of [1] to [4] described above, the first groove portion of the second center main groove 23 is inclined in an identical direction in the tire circumferential direction with respect to the long portion of the first center main groove 22 (see FIG. 6). This has the advantage that the rigidity of the center land portion 33 is made uniform in the tire circumferential direction, thereby suppressing uneven wear of the center land portion 33.

Further, [6] in the tire 1 according to any one of [1] to [5] described above, the circumferential length L31 of the first groove portion of the second center main groove 23 is in a range 0.35≤L31/P3≤0.75 with respect to a pitch length P3 of the bent shape of the second center main groove 23 (see FIG. 6). This has the advantage that the lower limit described above ensures the circumferential length L31 of the long first groove portion, thereby ensuring the effect of improving snow discharge properties on snowy road surfaces, and the upper limit described above ensures edge components of the short second and third groove portions, thereby ensuring the snow traction properties of the tire.

Further, [7] in the tire 1 according to any one of [1] to [6] described above, the circumferential length L32 of the second groove portion of the second center main groove 23 is in a range 0.20≤L32/P3≤0.45 with respect to a pitch length P3 of the bent shape of the second center main groove 23 (see FIG. 6). This has the advantage that the circumferential length L32 of the short second groove portion is properly set.

Further, [8] in the tire 1 according to any one of [1] to [7] described above, the circumferential length L33 of the third groove portion of the second center main groove 23 is in a range 0.05≤L33/P3 with respect to a pitch length P3 of the bent shape of the second center main groove 23 (see FIG. 6). This has the advantage that edge components of the short third groove portion are ensured, thereby ensuring the snow traction properties of the tire.

Further, [9] in the tire 1 according to any one of [1] to [8] described above, a pitch length P3 of the bent shape of the second center main groove 23 is in a range 0.80≤P3/P2≤1.20 with respect to a pitch length P2 of the zigzag shape of the first center main groove 22 (see FIG. 6). This has the advantage that the rigidity of the tread portion center region is made uniform, thereby suppressing uneven wear of the tire.

Further, in the tire 1 according to any one of [1] to [9] described above, an amplitude A3 of the bent shape of the second center main groove 23 is in a range 0.55≤A3/Wg3≤0.95 with respect to a groove width Wg3 of the second center main groove 23 (see FIG. 6). This has the advantage that the lower limit described above ensures an effect of improving snow traction performance by the bent shape, and the upper limit described above suppresses generation of uneven wear due to excessive enlargement of the amplitude.

Further, in the tire 1 according to any one of [1] to described above, an amplitude A3 of the bent shape of the second center main groove 23 is in a range 0.80≤A3/A2≤1.20 with respect to an amplitude A2 of the zigzag shape of the first center main groove 22 (see FIG. 6). This has the advantage that the rigidity of the tread portion center region is made uniform, thereby improving the uneven wear resistance of the tire.

Further, in the tire 1 according to any one of [1] to described above, the center land portion 33 includes a first center lug groove 331A and a second center lug groove 331B extending through the center land portion 33 in a tire width direction, the first center lug groove and the second center lug groove being connected to each of the first center main groove 22 and the second center main groove 23 (see FIG. 6). The first center lug groove 331A and the second center lug groove 331B are inclined in mutually opposite directions with respect to the tire circumferential direction. This has the advantage that the snow traction properties in the center land portion 33 are improved.

### Target of Application

In this embodiment, as described above, a pneumatic tire is described as an example of a tire. However, no such limitation is intended, and the configurations described in the embodiments can also be applied to other tires in a discretionary manner within the scope obvious to one skilled in the art. Examples of other tires include an airless tire and a solid tire.

### Examples

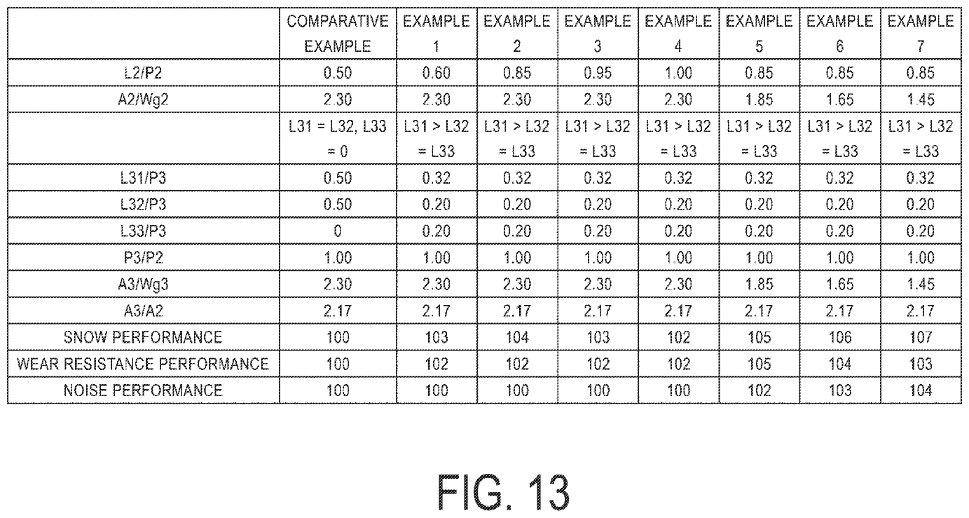

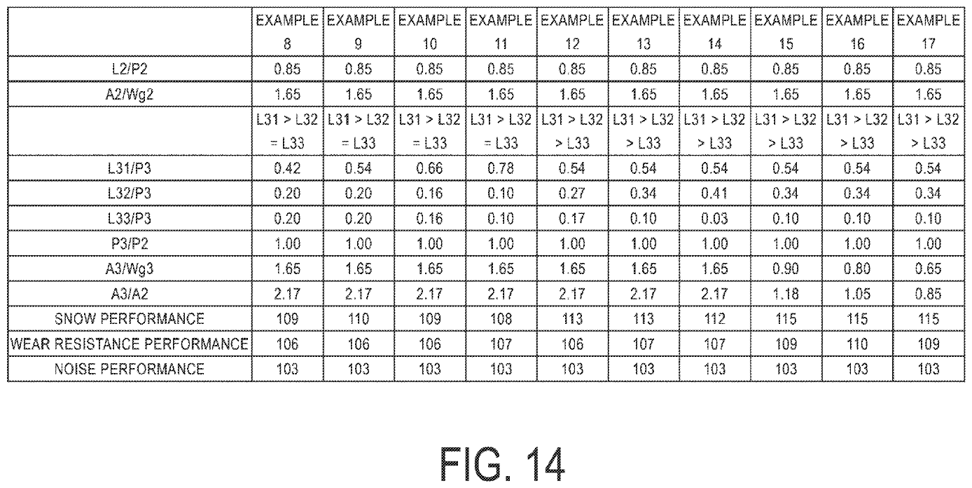

FIGS. 13 and 14 are tables showing results of performance tests of tires according to embodiments of the technology.

In the performance tests, a plurality of types of test tires were evaluated in terms of (1) snow performance and (2) (uneven) wear resistance performance. Additionally, test tires having a tire size of 225/65R17 102H were assembled on a rim having a rim size of 17×6.5 J, and an internal pressure of 230 kPa and a load specified by JATMA were applied to the test tires. In addition, the test tires were mounted on all wheels of a 4WD vehicle of a sports utility vehicle (SUV) as a test vehicle.

(1) In the evaluation of snow performance, the test vehicle traveled at a speed of 40 km/h on a predetermined handling course that was a snow road, and the test driver performed a sensory evaluation regarding the steering stability. The results are expressed as index values and evaluated, with Comparative Example being assigned as the reference (100). In the evaluation, larger values are preferable.

(2) In the evaluation of wear resistance performance, after the test vehicle had been driven for 8000 km on a predetermined off-road course, the difference in the amount of wear between the shoulder land portion 31 and the center land portion 33 was measured and evaluated. The results are expressed as index values and evaluated, with Comparative Example being assigned as the reference (100), and larger values are preferable since the difference in the amount of wear is small.

Each of the test tires of Examples includes the configurations of FIGS. 1 and 2. Four main grooves 21 to 24 have the zigzag shape or the bent shape with the amplitude in the tire width direction. In addition, in FIG. 2, the tire ground contact width TW is 172 mm, and the maximum ground contact widths of the land portions 31 to 35 are Wb1=33.5 mm, Wb2=33.5 mm, Wb3=33.8 mm, Wb4=29.5 mm, and Wb5=33.5 mm. Further, in FIGS. 3 and 10, the groove widths of the long portions of the zigzag shape of the main grooves 21, 22, 24 are Wg1=8.0 mm, Wg2=5.2 mm, and Wg4=8.0 mm. Further, the groove width of the first groove portion of the bent shape of the inner center main groove 23 is Wg3=5.2 mm.

The test tire of Comparative Example has the same configuration as the tire of Example 1 except that the outer and inner shoulder main grooves 21, 24 have a zigzag shape formed by alternately connecting long portions and short portions, and the outer and inner center main grooves have a zigzag shape formed by alternately connecting groove portions having the same length. In addition, the pitch lengths P1, P4 of the zigzag shape of the outer and inner shoulder main grooves 21, 24 are ½ with respect to the pitch lengths P2, P3 of the outer and inner center main grooves.

As can be seen from the test results, the test tires of the Examples provide snow performance and uneven wear resistance performance of a tire in a compatible manner.

1. A tire comprising:
a plurality of main grooves extending in a tire circumferential direction; and
a plurality of land portions defined and formed by the plurality of main grooves;
the plurality of main grooves comprising a first center main groove and a second center main groove adjacent to each other with a tire equatorial plane interposed between the first center main groove and the second center main groove,
the plurality of land portions comprising a center land portion defined and formed by the first center main groove and the second center main groove,
the first center main groove having a zigzag shape formed by alternately connecting a long portion and a short portion,
the second center main groove having a bent shape formed by connecting a first groove portion having a circumferential length L31, a second groove portion having a circumferential length L32, and a third groove portion having a circumferential length L33, and
the circumferential lengths L31 to L33 of the first groove portion to the third groove portion having a relationship L31>L32≥L33.

2. The tire according to claim 1, wherein a circumferential length L2 of the long portion of the first center main groove is in a range 0.60≤L2/P2≤1.00 with respect to a pitch length P2 of the zigzag shape of the first center main groove.

3. The tire according to claim 1, wherein an amplitude A2 of the zigzag shape of the first center main groove is in a range 1.40≤A2/Wg2≤1.90 with respect to a groove width Wg2 of the first center main groove.

4. The tire according to claim 1, wherein the first groove portion of the second center main groove, and the second groove portion and the third groove portion of the second center main groove are inclined in mutually opposite directions in the tire circumferential direction.

5. The tire according to claim 1, wherein the first groove portion of the second center main groove is inclined in an identical direction in the tire circumferential direction with respect to the long portion of the first center main groove.

6. The tire according to claim 1, wherein the circumferential length L31 of the first groove portion of the second center main groove is in a range 0.35≤L31/P3≤0.75 with respect to a pitch length P3 of the bent shape of the second center main groove.

7. The tire according to claim 1, wherein the circumferential length L32 of the second groove portion of the second center main groove is in a range 0.20≤L32/P3≤0.45 with respect to a pitch length P3 of the bent shape of the second center main groove.

8. The tire according to claim 1, wherein the circumferential length L33 of the third groove portion of the second center main groove is in a range 0.05≤L33/P3 with respect to a pitch length P3 of the bent shape of the second center main groove.

9. The tire according to claim 1, wherein a pitch length P3 of the bent shape of the second center main groove is in a range 0.80≤P3/P2≤1.20 with respect to a pitch length P2 of the zigzag shape of the first center main groove.

10. The tire according to claim 1, wherein an amplitude A3 of the bent shape of the second center main groove is in a range 0.55≤A3/Wg3≤0.95 with respect to a groove width Wg3 of the second center main groove.

11. The tire according to claim 1, wherein an amplitude A3 of the bent shape of the second center main groove is in a range 0.80≤A3/A2≤1.20 with respect to an amplitude A2 of the zigzag shape of the first center main groove.

12. The tire according to claim 1, wherein
the center land portion comprises a first center lug groove and a second center lug groove extending through the center land portion in a tire width direction, the first center lug groove and the second center lug groove being connected to each of the first center main groove and the second center main groove, and
the first center lug groove and the second center lug groove are inclined in mutually opposite directions with respect to the tire circumferential direction.
